(19) United States
(12) Patent Application Publication
(10) Pub. No.: US 2009/0034953 A1
(43) Pub. Date: Feb. 5, 2009

(54) Object-oriented photographing control method, medium, and apparatus

(75) Inventors: Young-kyoo Hwang, Seoul (KR); Jung-bae Kim, Hwaseong-si (KR); Seong-deok Lee, Suwon-si (KR); Gyu-tae Park, Anyang-si (KR); Jong-ha Lee, Hwaseong-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 12/004,429

(22) Filed: Dec. 21, 2007

(30) Foreign Application Priority Data
Jul. 31, 2007 (KR) 10-2007-0077176

(51) Int. Cl. G03B 13/00; H04N 5/235

(52) U.S. Cl. 396/95; 348/362; 348/E05.034

(57) ABSTRACT

An object-oriented photographing control method, medium, and apparatus. The object-oriented photographing control method includes detecting an interesting object registered in advance from an input image, estimating photographic information on the detected interesting object, and generating control information for capturing the input image by using the estimated photographing information, and capturing the input image according to the control information. Accordingly, states of a position and illuminance of the object are perceived in real-time, a high-quality image can be captured, and the user does not need to control the focus and the exposure of the input image.

### CROSS-REFERENCE TO RELATED APPLICATIONS

This application claims the benefit of Korean Patent Application No. 10-2007-0077176, filed on Jul. 31, 2007, in the Korean Intellectual Property Office, the disclosure of which is incorporated herein in its entirety by reference.

### BACKGROUND

1. Field

One or more embodiments of the present invention relate to an object-oriented photographing control method, medium, and apparatus, and more particularly, to a method, medium, and apparatus detecting a registered object and performing an object-oriented auto-focus and/or auto-exposure.

2. Description of the Related Art

The advent of digital cameras has permitted people to easily capture and store photographs and video digitally or through digital capturing, compared to conventional analog cameras. Here, digital cameras may have an auto-mode function, so that beginners can also easily take pictures, and because general customers typically have an increasing interest in photography and an increasing need for high-quality image acquisition. In order to satisfy this need, camera manufacturing companies have increased the pixel count of digital cameras for their customers. However, the average user does not need a pixel count greater than a certain level, and, further, a pixel count greater than this level may actually cause image quality deterioration.

In order to acquire high-quality images, the position and illuminance of an object in a scene shown through a viewfinder typically has to be perceived. In addition, control of auto-focus (AF), auto-exposure, and flash are desirable.

In order to bring the object into focus, the position of the object may be perceived and continuously tracked.

For this, a focusing technique is performed by reading a pattern of an object disposed along a center view area/line and tracking the pattern, as discussed in U.S. Patent Publication No. 2005-0264679.

However, in this focusing technique, since the pattern of the focus window disposed along the center view area/line is used, only a pattern of a portion of an object can be used, or a pattern of a background in addition to the object can be used. Here, when only the pattern of the portion of the object is used, in the case where occlusion or a change in the illuminance of the object occurs, it is difficult to continuously track the object. Further, when the pattern of the background, in addition to the object, is used, where the pattern of the background changes, the distance from the object shortens, or a zoom operation is implemented, the detection of the object is also difficult. In addition, the detection of a number of objects by using the aforementioned techniques is also impossible, so that bringing a number of objects into focus through depth of focus control is impossible.

Still further, typically, in order to accurately operate the auto-exposure, proper sensitivity, shutter speed, whether or not flash is to be used, and flash strength have to be determined by perceiving illuminance states and movement states of the object and the background.

For this, a technique for recognizing a face of a person as a designated object and performing auto-focus and auto-exposure according to that recognition has been discussed in U.S. Patent Publication No. 2005-0219395. However, this recognizing technique cannot be applied to an object that is not a person and setting the shutter speed according to body movement of a person is impossible.

### SUMMARY

One or more embodiments of the present invention provide an object-oriented photographing control method, medium, and apparatus capable of controlling focus and exposure by registering a picture of an object and perceiving a position and illuminance of the object in real-time, thereby enabling the capturing of a high-quality image.

Additional aspects and/or advantages will be set forth in part in the description which follows and, in part, will be apparent from the description, or may be learned by practice of the invention.

According to an aspect of the present invention, there is provided an object-oriented photographing control method including detecting an interesting object registered in advance from an input image, estimating photographic information on the detected interesting object, and generating control information for capturing the input image by using the estimated photographic information, and capturing the input image according to the control information.

According to another aspect of the present invention, there is provided an object-oriented photographing control apparatus, including an object detection unit detecting an interesting object registered in advance from an input image, an object-oriented control unit estimating one or more pieces of information on the detected object and capturing the input image by using the estimated photographic information and a photographing unit capturing the input image according to the control information.

According to another aspect of the present invention, there is provided a computer-readable medium having embodied thereon a computer program for performing the method.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an object-oriented photographing control apparatus, according to an embodiment of the present invention;

FIG. 2 illustrates an object-oriented photographing control apparatus, according to another embodiment of the present invention;

FIG. 3 illustrates an object registration unit of an object-oriented photographing control apparatus, such as that of FIG. 1, according to an embodiment of the present invention;

FIG. 4 illustrates an object registration unit of an object-oriented photographing control apparatus, such as that of FIG. 2, according to another embodiment of the present invention;

FIG. 5 illustrates a method of registering an interesting object, according to an embodiment of the present invention;

FIG. 6 illustrates an object detection unit of an object-oriented photographing control apparatus, such as those of FIG. 1 or 2, according to an embodiment of the present invention;

FIG. 7 illustrates an object-oriented control unit of an object-oriented photographing control apparatus, such as those of FIG. 1 or 2, according to an embodiment of the present invention;

FIG. 8 illustrates an object-oriented AF control method, according to an embodiment of the present invention;

FIG. 9 illustrates an object-oriented AE control method, according to an embodiment of the present invention;

FIG. 10 illustrates an object-oriented photographing control method, according to an embodiment of the present invention; and

FIG. 11 illustrates an object-oriented photographing control method, according to another embodiment of the present invention.

### DETAILED DESCRIPTION OF EMBODIMENTS

Reference will now be made in detail to embodiments, examples of which are illustrated in the accompanying drawings, wherein like reference numerals refer to like elements throughout. In this regard, embodiments of the present invention may be embodied in many different forms and should not be construed as being limited to embodiments set forth herein. Accordingly, embodiments are merely described below, by referring to the figures, to explain aspects of the present invention.

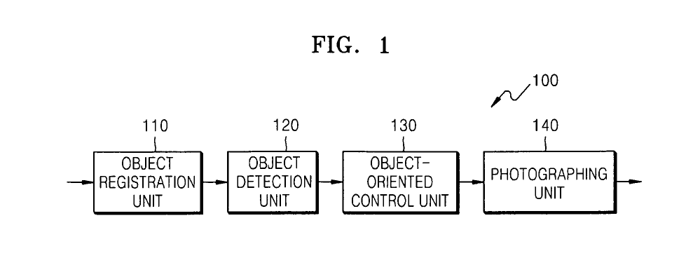

FIG. 1 illustrates an object-oriented photographing control apparatus 100, according to an embodiment of the present invention.

Referring to FIG. 1, the object-oriented photographing control apparatus 100 may include an object registration unit 110, an object detection unit 120, an object-oriented control unit 130, and a photographing unit 140, for example. Herein, the term apparatus should be considered synonymous with the term system, and not limited to a single enclosure or all described elements embodied in single respective enclosures in all embodiments, but rather, depending on embodiment, is open to being embodied together or separately in differing enclosures and/or locations through differing elements, e.g., a respective apparatus/system could be a single processing element or implemented through a distributed network, noting that additional and alternative embodiments are equally available.

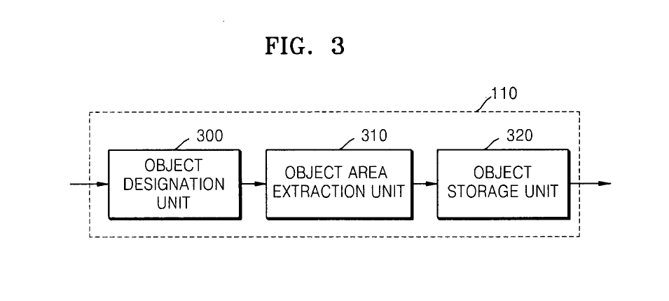

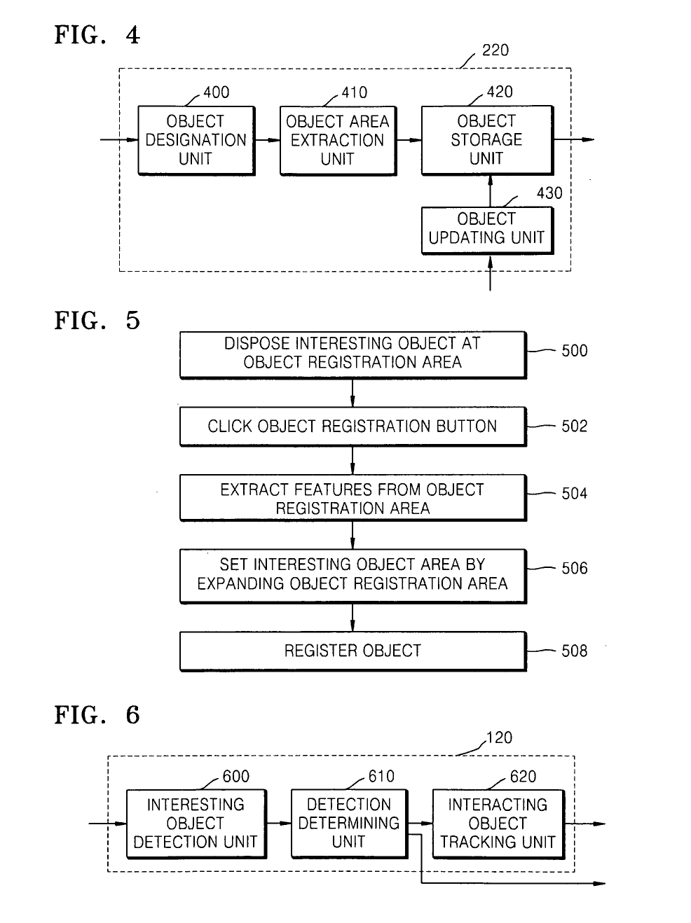

The object registration unit 110 may register an object to be photographed by a user. Here, the object is a thing to be photographed, for example, and one or more objects can be registered. As an example, an object which a user wants to photograph may be registered in a picture stored in a digital camera or the like by using a camera interface such as a designation button, a touch screen, a trackball, a stick, or the like, noting that alternatives are also available. Further detailed registration operations will be described with reference to FIGS. 3 and 4.

The object detection unit 120 may thereafter detect the same object, as registered in the object registration unit 110, from further input images. It may, thus, be determined whether the object registered in the object registration unit 110 is included in a scene which is then currently to be photographed, for example, the input image which the user can see through a viewfinder of the digital camera. Here, in order to detect the object, features of the input image and object images therein are extracted and it is determined whether the features are similar to the object registered in the object registration unit 110. Feature extraction may use scale invariant feature transform (SIFT), edge detection, or color feature extraction, for example, noting that alternatives are also available. SIFT is an algorithm for extracting features robust to changes in scale and rotation of an image, edge detection includes extracting an edge image from an image, and extracting a feature by using an average value of the extracted edge, and a color feature is one of the most distinctive visual features of an image. Color feature extraction may use a color histogram of the image, calculate intensity values of a color image by using the histogram to extract color features, and compare similarities between the color features.

In addition, the object detection unit 120 may repeatedly track the detected object. Here, in order to track the object, a particle filter, mean shift, or Kanade-Lucas-Tomasi (KLT) feature tracker, which are known, may be used, noting that alternatives are also available.

The object-oriented control unit 130 may estimate photographic information on the objected detected by the object detection unit 120 and generate control information by using the estimated photographic information. Here, the photographic information may include a change in a size of the object estimated on the basis of the detected object, a distance to the object, an illuminance of the object, a movement of the object, an illuminance of a background of the input image, a movement of the background, a degree of back light, and the like, noting that alternatives are also available. Here, photographic information estimation is an estimate of the photographic information in a state in which the interesting object of the user is recognized from the input image. Therefore, this photographic information estimation has good auto-focus (AF) and auto-exposure (AE) performance compared with the aforementioned existing camera control techniques, such as a technique of performing AF by tracking a pattern disposed at a focus window at the center and a technique of performing the AF by measuring a speed of the pattern disposed at the center focus area and controlling the shutter speed.

Here, the control information may include a lens step for the AF, a shutter speed, an exposure value, information on whether or not flash is used, information on whether or not strength of the flash is controlled, information on whether or not an auto-slow-sync mode is used, and the like.

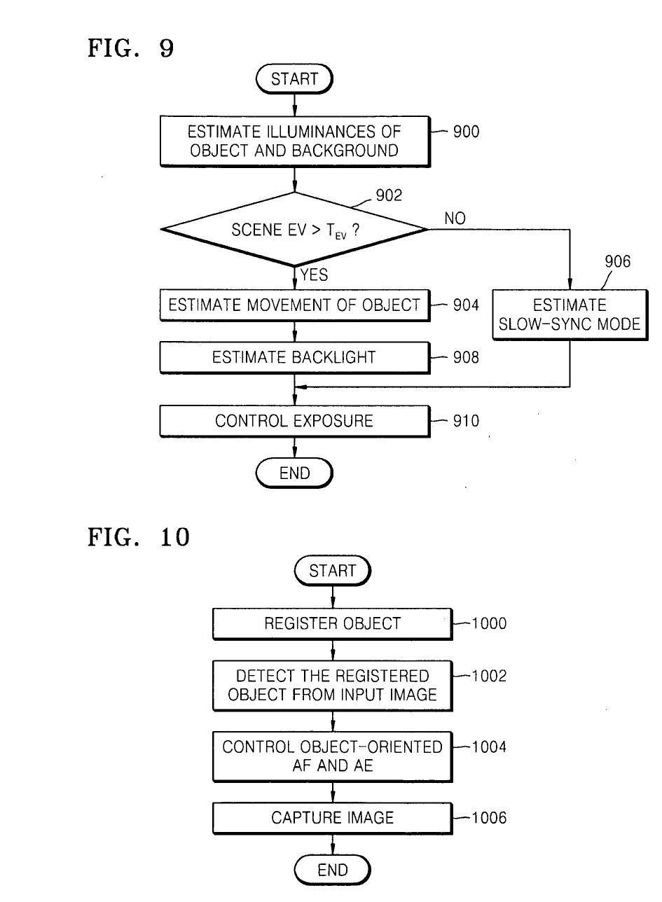

Embodiments of the photographic information and the control information will be further described below with reference to FIGS. 8 and 9.

The photographing unit 140 may receive the control information from the object-oriented control unit 130 and capture an input image according to the control information. For example, the photographing unit 140 may capture the image as the user presses the shutter button in a state where object-oriented auto-control and auto-exposure are performed on the viewfinder.

The object-oriented photographing control apparatus 100, according an embodiment may, thus, include the object registration unit 110. However, the object registration unit 100 may be excluded, for example, when an external device such as an external server or a personal computer (PC) registers the interesting object and the registered object is downloaded to the object-oriented photographing control apparatus 100 so that photographing is performed.

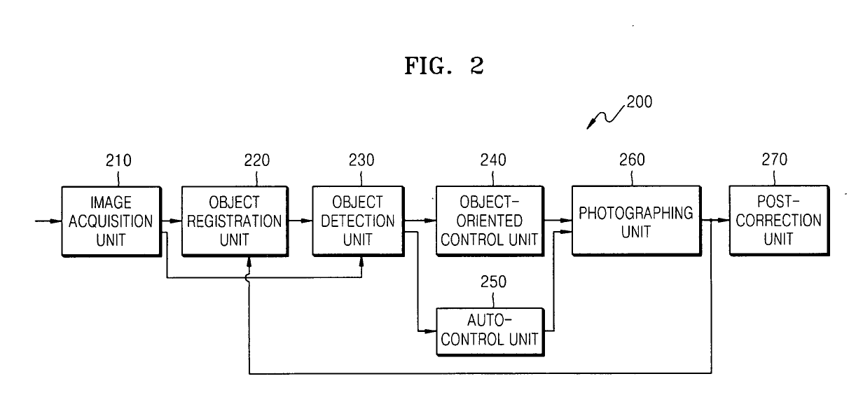

FIG. 2 illustrates an object-oriented photographing control apparatus 200, according to another embodiment of the present invention.

As compared with the object-oriented photographing control apparatus 100 illustrated in FIG. 1, the object-oriented photographing control apparatus 200 illustrated in FIG. 2, according to another embodiment of the present invention, may include an image acquisition unit 210, an object registration unit 220, an object detection unit 230, an object-oriented control unit 240, an auto-control unit 250, a photographing unit 260, and a post-correction unit 270, for example.

The image acquisition unit 210 may acquire an image of a scene to be photographed by the user, for example, and provide the image to the object registration unit 220. In addition, the image acquisition unit 210 may provide the image of the scene to the object detection unit 230 to detect an interesting object, as already registered by the object registration unit 220, from the current input image.

When the object detection unit 230 does not detect the already registered object within the input image, the auto-control unit 250 may collect photographic information on the current input image, generate camera control information by using the photographic information, and provide the control information to the photographing unit 260. Here, the auto-control unit 250 may generate the control information by using general control methods such as AF, AE, and the like, for example.

The photographing unit 260 may then capture the input image by using the control information provided from the object-oriented control unit 240 and the auto-control unit 250. Here, the photographing unit 260 may again output the captured image to the object registration unit 220, and the object registration unit 220 may again attempt to detect the registered object from the received image. When, or if, the registered object is detected, the object registration unit 220 may then update the stored object registration.

The post-correction unit 270 may further perform post-processing to collect data of the captured image. Here, the post-processing may include correction of backlight, generation of metadata for album generation, and the like, for example.

FIG. 3 illustrates the object registration unit 110 of the object-oriented photographing control apparatus 100 of FIG. 1, for example, according to an embodiment of the present invention.

Referring to FIG. 3, here, the object registration unit 110 may include an object designation unit 300, an object area extraction unit 310, and an object storage unit 320, for example.

The object designation unit 300 may designate one or more points of or in the interesting object. Otherwise, the object designation unit 300 may designate an area to which the interesting object belongs. The designation may be performed using a designation button, a touch screen, a trackball, a stick, or the like, which is attached to the digital camera.

In a method of designating the interesting object, e.g., using the designation button according to an embodiment of the present invention, an arrow, a window, a point, or the like may be disposed at or near the object based upon by control of a multi-direction button, and such a designation button may be pressed/engaged. Alternatively, when such an arrow is disposed at a position seen in the view finder by using the multi-direction button, an example rectangular window may be set by the designation button being pressed, the arrow disposed at another position, and the designation button again being pressed, and an area of the total area or a portion of an area of the interesting object may be included in the rectangular window.

In a method of designating the interesting object using an example touch screen, according to an embodiment, an area including the object on the screen can further be set by hand or through implementing a pen. Again, for example, the hand or the pen may be moved in a state where the hand or the pen presses the screen to set a rectangular window based on a starting point and an ending point, and the total area or a portion of an area of the interesting object may be included in the rectangular window.

In a method of designating the interesting object using an example trackball according to an embodiment, an arrow, a window, a point, or the like may be disposed at or near the object by the trackball, and a ball or a button pressed/engaged. Again, as an alternative, the arrow, the window, the point, or the like may be disposed at or near a position by the trackball, the ball or the button pressed/engaged, the arrow disposed at another position, and the button again pressed/engaged, setting a rectangular window based on the designated two positions, such that the total area or a portion of an area of the interesting object may be included in the rectangular window.

In a method of designating the interesting object using an example stick, according to an embodiment, an arrow, a window, a point, or the like may be disposed at or near the object by the stick, and the stick or a button pressed/engaged. Again, as an alternative, the arrow, the window, the point, or the like may be disposed/engaged at or near a position by the stick, the stick or the button pressed/engaged, the arrow disposed at another position, and the button again pressed/engaged, setting a rectangular window based on the designated two positions, such that the total area or a portion of an area of the interesting object may be included in the rectangular window.

In the example aforementioned methods of designating the interesting object, according to embodiments of the present invention, such an example rectangular window may be used for designation. However, other windows having any kind of a closed shape, for example, may also be used. For example, in a state in which the designation button is pressed, a window having a shape corresponding to a shape of the object may be set. Here, alternative designating techniques are also available, and embodiments of the present invention should not be limited to the same.

As noted in the above example, the object area extraction unit 310 may extract the area of the interesting object on the basis of the point or the area designated by the object designation unit 300. Here, the area object means an area including a main portion of the interesting object, the total area of the interesting object, or an area including the interesting object.

In addition, selectively, the user may also be permitted to cancel the registration of the interesting object. For example, when the user presses a predetermined registration button for a designated long time, all of the registered objects may be displayed on a display screen, and the user may select and delete a desired object, noting that alternatives are also available.

In an embodiment, the object storage unit 320 may also be used to store the interesting object extracted by the object area extraction unit 310.

FIG. 4 illustrates an object registration unit 220 of the object-oriented photographing control apparatus 200 of FIG. 2, for example, according to an embodiment of the present invention.

Referring to FIG. 4, the object registration unit 220, according such an embodiment, may include an object designation unit 400, an object area extraction unit 410, an object storage unit 420, and an object updating unit 430, for example.

The object updating unit 430 may receive the image, e.g., as captured by the photographing unit 260 illustrated in FIG. 2, and determine whether the pre-designated interesting object is detected within the image. In an embodiment, when the interesting object is detected, the pre-designated interesting object stored in the object storage unit 420 may be updated on the basis of the interesting object existing in the captured image.

FIG. 5 illustrates a method of registering the interesting object, according to an embodiment of the present invention.

Referring to FIG. 5, in operation 500, the interesting object may be disposed/available to an object registration area of a digital camera. Next, for example, when the user clicks an object registration button of the digital camera, in operation 502, features of the interesting object are extracted from the object registration area, in operation 504. Feature extraction may use texture feature or color feature extraction and the like. In operation 506, an interesting object area may be further set by expanding the object registration area. Setting of the interesting object area may then use a mean shift image segmentation method based on the extracted features. In operation 508, the object may then be registered through the aforementioned user interfaces such as the button and the touch screen.

FIG. 6 illustrates the object detection unit 120 of the object-oriented photographing control apparatus 100 of FIG. 1, for example, according to an embodiment of the present invention. The diagram of FIG. 6 can also be applied to the object detection unit 230 of the object-oriented photographing control apparatus 200 of FIG. 2, also as an example.

Referring to FIG. 6, in this embodiment, the object detection unit 120 may include an interesting object detection unit 600, a detection determining unit 610, and an interacting object tracking unit 620, for example.

The interesting object detection unit 600 may extract features from the input image and the pre-designated interesting object, e.g., as registered in the object registration unit 110, and calculate similarities between the extracted features of the input image and the pre-designated interesting object. Here, feature extraction may include dividing the total image into sub-images and extracting a descriptor from each sub-image. Further, in an embodiment, the descriptor, scale invariant feature transform (SIFT), or color moment may be used, for example. In addition, in order to calculate the similarities, a Euclidean distance, a mutual information distance, or the like may further be used, again noting that alternatives are also available.

The detection determining unit 610 may compare a maximum value of the similarities calculated by the interesting object detection unit 600 with a predetermined critical value and identify whether the maximum value is met, e.g., whether the maximum value is equal to or greater than the critical value. Here, the critical value may be a reference value for determining whether the registered object has been detected within the input image. In addition, in an embodiment, when the maximum value of the similarities has not been met, e.g., the maximum value is less than the critical value, the detection determining unit 610 may provide the input image to the auto-control unit 250 illustrated in FIG. 2, for example, so as to allow the auto-control unit 250 to generate control information by estimating photographic information from the input image.

The object tracking unit 620 may further track the features of the detected interesting object based on a result of the determining of the detection determining unit 610. Here, a tracking algorithm including mean shift, a particle filter, or the like may be used, for example. By tracking the features of the detected object using the tracking algorithm, according to an embodiment, presence of the object may be more precisely determined.

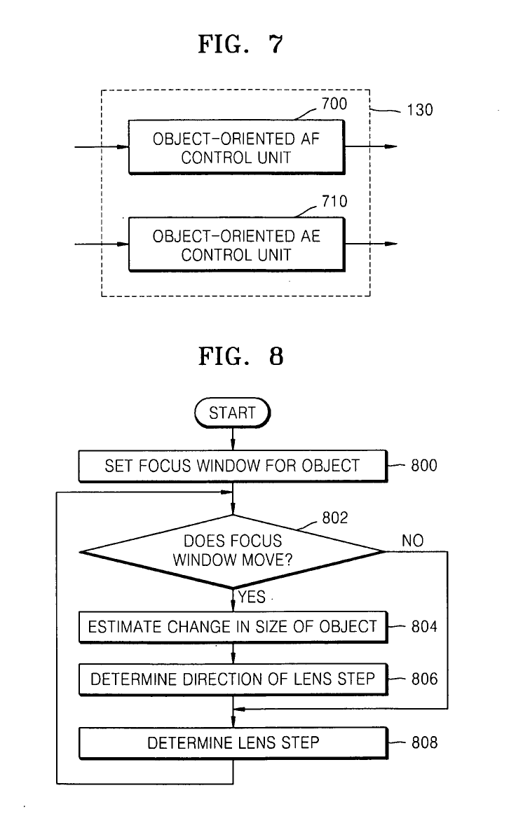

FIG. 7 illustrates the object-oriented control unit 130 of the object-oriented photographing control apparatus 100 of FIG. 1, for example, according to an embodiment of the present invention. The diagram of FIG. 7 can also be applied to the object-oriented control unit 240 of the object-oriented photographing control apparatus 200 of FIG. 2, also as an example.

Referring to FIG. 7, in an embodiment, the object-oriented control unit 130 may include an object-oriented AF control unit 700 and an object-oriented AE control unit 710, for example. Alternatively, the object-oriented control unit 130 may selectively include the AF control unit 700 and/or the AE control unit 710.

Such an object-oriented AF control unit 700 brings the detected object into focus, and when the object moves, estimates the change in size of the object, determines the direction of a lens step, and determines the precise lens step. Here, the lens step is information for determining an opening degree of a camera lens aperture, and focusing may be performed according to the information on the opening degree of the aperture.

The object-oriented AE control unit 710 may estimate an illuminance of the detected object and an illuminance of a corresponding background. When an exposure value (EV) meets, e.g., is larger than, a predetermined critical value, the object-oriented AE control unit 710 may estimate the movement of the object and estimate a backlight state. Here, the critical value can be a reference value for determining a state of the illuminance, and may be predefined. In addition, when the exposure value EV fails to meet, e.g., is smaller, than the critical value, it may be determined whether a slow-sync mode is set. The object-oriented AE control unit 710 may further control ISO, a shutter speed, F#, whether or not flash is to be used, a flash strength, or the like, on the basis of the estimated degrees.

For example, in such an embodiment, when the brightness is high and a blur occurs in the object area, the shutter time may be reduced to have a fast shutter speed. When there is backlight against the object and the object is disposed within a flash effective distance, the flash strength may be selectively controlled, and when the object is disposed outside the effective distance, photometry may be performed. In addition, when the illuminance of the object is too low, whether or not the flash is to be used may be determined, and when a high-quality image can be acquired by controlling the ISO and the shutter time, the flash is not used. Similarly, when the flash is to be used, whether or not the slow-sync mode is to be used may be determined, and the flash strength, ISO, opening and closing the aperture, and the shutter time controlled.

FIG. 8 illustrates an object-oriented AF control method, according to an embodiment of the present invention.

Referring to FIG. 8, in operation 800, a focus window may be set for a detected object. In operation 802, it is determined whether the focus window moves between captured or sample images, and when the focus window moves, a change in the size of the object may be estimated, in operation 804. In operation 806, a direction of the lens step may be estimated according to a value of the change in the size of the object, and in operation 808, a precise lens step is determined. In operation 802, when the focus window is determined to not have moved, operation 808 is performed to determine the lens step.

FIG. 9 illustrates an object-oriented AE control method, according to an embodiment of the present invention.

Referring to FIG. 9, in operation 900, the illuminance of a detected object and the illuminance of a background may be estimated. In operation 902, it is determined whether the exposure value EV of a scene to be photographed meets, e.g., is equal to or greater than, a predetermined critical value T_{EV}. Here, the exposure value EV may be calculated by detected object-oriented photometry. When the exposure value EV meets, e.g., is equal to or greater than, the critical value T_{EV}, in operations 904 and 908, a movement and backlight of the detected object may be estimated. Such a movement of the object estimates a degree of a dominant blur area and calculates the number of moving pixels per frame of an input RGB image to estimate a speed, for example. Therefore, by using the speed and the number of frames per second, the shutter time tmb can be estimated, and accordingly the shutter speed may be selectively controlled. The backlight estimation determines whether a ratio of an average luminance of the object and an average luminance of the background fails to meet, e.g., is less than, a predetermined critical value Tb. Here, the critical value Tb may be a reference value set in advance to determine the backlight. When the luminance fails to meet the critical value Tb, it may be estimated that there is backlight, and otherwise, it may be estimated that there is no backlight.

When the exposure value EV fails to meet this example critical value T_{EV} in operation 902, a slow-sync mode may be estimated in operation 906. Here, the slow-sync mode is a mode of performing an embedded flash technique or a slow shutter speed function. Slow-sync mode estimation determines whether the average luminance of the object/the average luminance of the background fails to meet, e.g., is less than, a predetermined critical value Ti. This example critical value Ti can be a predefined reference for determining the slow-sync mode. As a result of this determining, for example, when the average luminance of the object/the average luminance of the background is less than the critical value Ti, the slow-sync mode is set, and otherwise, the slow-sync mode is not set.

In operation 910, exposure control information may be generated by using the photographic information estimated in operations 904 to 908, for example. Here, the exposure control information can include ISO, a shutter time, F#, whether or not flash is to be used, a flash strength, a distance from the object, and the like, noting that alternatives area also available. Specifically, the shutter time may be according to an estimating of the movement of the object, photographing for a high-quality image may be performed according to an estimating of backlight by using the illuminances of the object and the background, the photographing for a high-quality image may be performed according to an automating of the slow-sync mode setting by using the illuminances of the object and the background, the photographing for a high-quality image may be performed according to a restraining of the flash using by using the illuminances of the object and the background, and the flash strength may be controlled according to an estimating of the distance from the object. Here, again, it is noted that alternative embodiments are also available.

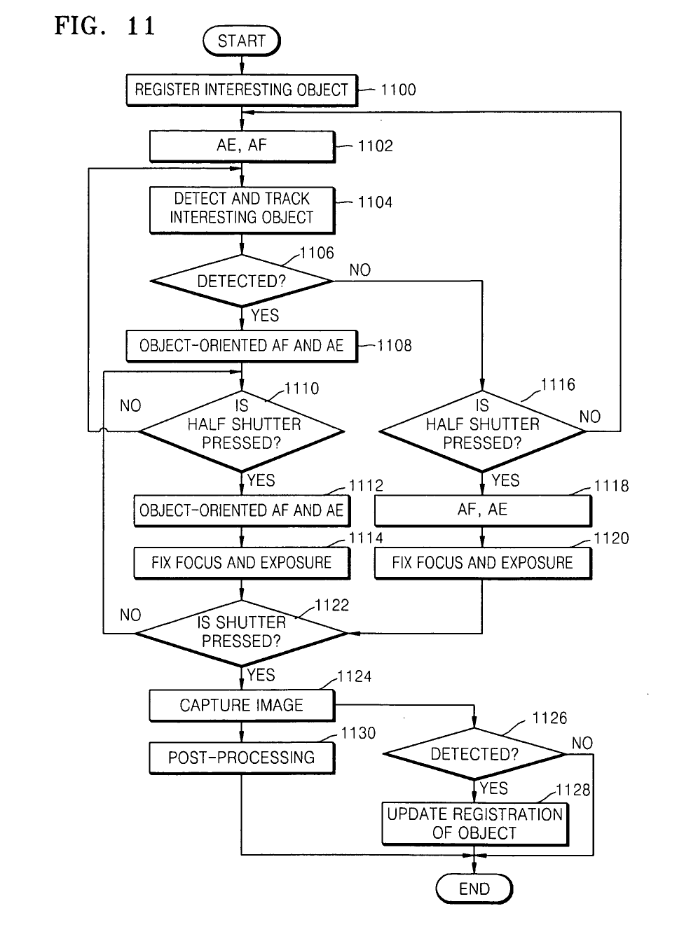

FIG. 10 illustrates an object-oriented photographing control method, according to an embodiment of the present invention.

Referring to FIG. 10, in operation 1000, an interesting object may be registered, e.g., by a user of a corresponding photographing apparatus. In operation 1002, the registered interesting object may detected within an input image. In operation 1004, the object-oriented AF control and/or the object-oriented AE control may be performed based on the detected interesting object in the input image. In operation 1006, the input image may then be captured according to the AF control and/or AE control.

FIG. 11 illustrates an object-oriented photographing control method, according to another embodiment of the present invention.

Referring to FIG. 11, in operation 1100, a picture of an interesting object may be registered, e.g., by a user of a corresponding photographing apparatus. In operation 1102, general AF and AE may be performed on another, for example, scene to be photographed through the viewfinder. In operation 1104, detecting and tracking of the interesting object registered in advance may be performed on the input image scene. Herein, the term “registered in advance” is defined, including for interpretations of the attached claims, as having been registered at least in the registering of the interested object, e.g., by the user, before that operation, or an updating of the same. Accordingly, when the interesting object is detected in operation 1106, the object-oriented AF and AE may then be performed in operation 1108. Next, in operation 1110, when/if a half shutter is pressed, the object-oriented AF and AE may be performed in operation 1112, and the focus and the exposure of the input image fixed in operation 1114. When it is determined that the half shutter has not been pressed, operation 1104 may be performed to repeat the detecting and tracking the interesting object. When the shutter is pressed in operation 1122, the input image may then be photographed in operation 1124, and post-processing for collecting data of photographing results performed in operation 1130.

When the registered object is not detected within the input image in operation 1106, and when the half shutter is determined to have been pressed in operation 1116, the AF and AE may be performed in operation 1118, and the focus and the exposure of the input image fixed in operation 1120. Thereafter, in operation 1126, it may again be determined whether the registered object is detected within the input image, and when/if the registered object is then detected, the stored object registration may be updated in operation 1128.

The object-oriented photographing control method, medium, and apparatus, according to one or more embodiments of the present invention, can be applied to any kind of image capturing apparatus such as a mobile phone with a camera, in addition to digital cameras, noting that additional alternatives are also available.

Accordingly, in one or more embodiments of the present invention, an interesting object that has previously been registered, i.e., ‘an interesting object registered in advance’, may be detected as being present in an input image, photographic information on the detected interesting object may be estimated, control information for capturing the input image generated by using the estimated photographic information, and the input image captured according to the control information. Therefore, in one or more embodiments, position and state of the illuminance of the object may be perceived in real-time, so that high-quality images can be captured and the user does not need to control the focus and the exposure.

In addition to the above described embodiments, embodiments of the present invention can also be implemented through computer readable code/instructions, e.g., a computer program, in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs), and transmission media such as media carrying or including carrier waves, as well as elements of the Internet, for example. Thus, the medium may be such a defined and measurable structure including or carrying a signal or information, such as a device carrying a bitstream, for example, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

While aspects of the present invention has been particularly shown and described with reference to differing embodiments thereof, it should be understood by those skilled in the art that various changes in form and details may be made therein without departing from the spirit and scope of the. The above embodiments should be considered in descriptive sense only and not for purposes of limitation.

Thus, although a few embodiments have been shown and described, it would be appreciated by those skilled in the art that changes may be made in these embodiments without departing from the principles and spirit of the invention, the scope of which is defined for the present application in the claims and their equivalents.

What is claimed is:

1. An object-oriented photographing control method comprising;
(a) detecting an interesting object registered in advance from an input image;
(b) estimating photographic information on the detected interesting object, and generating control information for capturing the input image by using the estimated photographic information; and
(c) capturing the input image according to the control information.

2. The method of claim 1, further comprising registering one or more interesting objects,
wherein control information to perform object-oriented auto-focus control and auto-exposure control on the input image is generated.

3. The method of claim 2, wherein the registering one or more interesting objects comprises:
designating one or more points in each of the one or more interesting objects or designating a predetermined area to which each of the one or more interesting objects belongs;
extracting an area of each of the one or more interesting objects on the basis of the one or more designated points and the designated predetermined area; and
storing the extracted area of the one or more interesting objects.

4. The method of claim 3, wherein the designating comprises designating the one or more points or the area by using a predetermined designation button, a touch screen, a trackball, or a stick.

5. The method of claim 3, wherein the area of the object comprises one of an area of a portion of each of the one or more interesting objects, the total area of each of the one or more interesting objects, and the area including the interesting object.

6. The method of claim 1, wherein the detecting the interesting object comprises:
extracting features of the input image and the registered interesting object, and calculating similarities between the extracted features;
determining whether or not a maximum value of the calculated similarities is greater than a predetermined reference value; and
tracking the detected interesting object according to a result of the determining.

7. The method of claim 6, further comprising, after the determining, when the maximum value of the calculated similarities is less than the predetermined reference value, generating auto control information on the basis of the photographic information on the input image, and capturing the input image according to the auto control information.

8. The method of claim 1, further comprising performing post-processing to collect data of the captured image after capturing the input image.

9. The method of claim 1, further comprising:
after capturing the input image, detecting whether or not the object is included in the captured image; and
updating registration of the object according to a result of the detecting.

10. The method of claim 1, wherein the photographic information comprises one or more of a change in a size of the object, a distance from the object, an illuminance of the object, a movement of the object, an illuminance of a background of the input image, a movement of the background, and backlight.

11. The method of claim 1, wherein the control information comprises one or more of a lens step, a shutter speed, an exposure value, whether or not flash is used, and a flash strength.

12. A computer-readable medium having embodied thereon a computer program for performing the method of claim 1.

13. An object-oriented photographing control apparatus, comprising:
an object detection unit detecting an interesting object registered in advance from an input image;
an object-oriented control unit estimating one or more pieces of information on the detected object and capturing the input image by using the estimated photographic information; and
a photographing unit capturing the input image according to the control information.

14. The apparatus of claim 13, further comprising an object registration unit registering one or more interesting objects,
wherein the object-oriented control unit generates control information to perform object-oriented auto-focus control and auto-exposure control on the input image.

15. The apparatus of claim 14, wherein the object registration unit comprises:
an object designation unit designating one or more points in each of the one or more interesting objects or designating a predetermined area to which each of the one or more interesting objects belongs;
an object area extraction unit extracting an area of each of the one or more interesting objects on the basis of the one or more designated points and the designated predetermined area; and
an object storage unit storing the extracted area of each of the one or more interesting objects.

16. The apparatus of claim 15, wherein the object designation unit designates the one or more points or the area by using a predetermined designation button, a touch screen, a trackball, or a stick.

17. The apparatus of claim 13, wherein the object detection unit comprises:
an interesting object detection unit extracting features of the input image and the registered interesting object, and calculating similarities between the extracted features;
a detection determining unit determining whether or not a maximum value of the calculated similarities is equal to or greater than a predetermined reference value; and
an interesting object tracking unit tracking the detected interesting object according to a result of the determining.

18. The apparatus of claim 17, further comprising, when the maximum value of the calculated similarities is less than the reference value, estimating the photographic information on the input image and generating auto control information on the basis of the estimated photographic information,
wherein the photographing unit captures the input image according to the auto control information.

19. The apparatus of claim 14, wherein the object registration unit detects whether or not the object is included in an image obtained by capturing the input image and updates registration of the object according to a result of the detecting.

20. The apparatus of claim 13, further comprising a post-processing unit performing post-processing to collect data of the image obtained by the capturing of the input image.
